(19) United States
(12) Patent Application Publication
(10) Pub. No.: US 2021/0005866 A1
(43) Pub. Date: Jan. 7, 2021

(54) POWER STORAGE PACK AND EXTERNAL CONNECTION MODULE SYSTEM

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventors: Naoki FUKUSHIMA, Mie (JP); Osamu NAKAYAMA, Mie (JP); Mitsutoshi MORITA, Mie (JP); Tetsuya FUJITA, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 16/911,977

(22) Filed: Jun. 25, 2020

(30) Foreign Application Priority Data
Jul. 5, 2019 (JP) 2019-125849

(51) Int. Cl. H01M 2/20; H01M 10/48; H01M 10/42; H01M 2/10; H01R 11/28; H01M 2/30

(52) U.S. Cl. CPC H01M 2/206; H01M 10/482; H01M 2/30; H01M 2/1016; H01R 11/281; H01M 10/425

(57) ABSTRACT

A power storage pack includes a plurality of power storage modules each including a power storage element group with a plurality of power storage elements having electrode terminals, and an external connection module electrically connected to the electrode terminals and including a short bus bar and a long bus bar for outputting power of the power storage element group, and an insulating member for insulating and holding the short bus bar and the long bus bar, the insulating member including a first unit for holding one end portion of the long bus bar and a second unit for holding another end portion of the long bus bar, the first unit has a first overlapping portion, the second unit has a second overlapping portion, and the first overlapping portion and the second overlapping portion have a variable length overlapping margin in which they overlap each other.

### TECHNICAL FIELD

The present disclosure relates to a power storage pack and an external connection module system.

### BACKGROUND ART

An external connection bus bar holding module disclosed in JP 2018-41713A includes a first external connection bus bar, a second external connection bus bar, a first protector portion for holding a first electrode connection portion of the first external connection bus bar, a second protector portion that is disposed at a distance from the first protector portion and is for holding the first external connection portion of the first external connection bus bar, and an intermediate protector portion. The intermediate protector portion is located between the first protector portion and the second protector portion, and holds an intermediate portion of the first external connection bus bar between the first protector portion and the second protector portion.

JP 2018-41713A is an example of related art.

### SUMMARY OF THE INVENTION

According to the above-described technique, when the length of the intermediate portion of the first external connection bus bar is made to correspond to a power extraction position of a power storage element group, the first protector portion and the second protector portion can be directly utilized, and the length thereof can be made to correspond to the power extraction position simply by changing the design of the length of the intermediate protector portion.

However, according to the above-described technique, multiple types of intermediate protector portions having different lengths need to be prepared in correspondence with the intermediate portions of the first external connection bus bars having different lengths, and thus there is a concern that the number of components will increase. An increase in the number of components is not preferable because manufacturing costs will increase.

The present disclosure has been accomplished based on the above-described circumstances, and aims to provide a technique by which the manufacturing cost of a power storage pack can be reduced.

The present disclosure is a power storage pack that includes a plurality of power storage modules, in which the plurality of power storage modules each include a power storage element group in which a plurality of power storage elements having electrode terminals are arranged side-by-side in an arrangement direction, and an external connection module that is electrically connected to the electrode terminals of the plurality of power storage elements, the external connection module includes a short bus bar for outputting power of the power storage element group, a long bus bar that is for outputting power of the power storage element group and is longer than the short bus bar with regard to the arrangement direction, and an insulating member for insulating and holding the short bus bar and the long bus bar, the insulating member includes a first unit for holding one end portion of the long bus bar and a second unit for holding another end portion of the long bus bar with regard to the arrangement direction, the first unit has a first overlapping portion, the second unit has a second overlapping portion, the first overlapping portion and the second overlapping portion have an overlapping margin and overlap each other along the arrangement direction, and a length of the overlapping margin in the arrangement direction is variable, and the plurality of power storage modules include a plurality of types of power storage modules to which a plurality of types of long bus bars having different lengths in the arrangement direction are attached.

According to the present disclosure, manufacturing costs can be reduced.

### BRIEF DESCRIPTION OF THE DRAWINGS

FIG. 1 is a cross-sectional view showing a power storage pack according to Embodiment 1;

FIG. 2 is a front view showing a low-profile power storage module;

FIG. 3 is a cross-sectional view taken along line III-III in FIG. 2;

FIG. 4 is a perspective view showing a low-profile wiring module;

FIG. 5 is a front view showing the low-profile wiring module;

FIG. 6 is a perspective view showing a state in which a low-profile external connection module is attached to the low-profile wiring module;

FIG. 7 is a cross-sectional view taken along line WI-WI in FIG. 8;

FIG. 8 is a front view showing the low-profile external connection module;

FIG. 9 is a rear view showing the low-profile external connection module;

FIG. 10 is a plan view showing a state in which a first unit and a second unit are attached to each other;

FIG. 11 is a partially enlarged perspective view showing a state in which a locking rib and a first locking claw are locked to each other;

FIG. 12 is a front view showing a high-profile power storage module;

FIG. 13 is a front view showing a high-profile wiring module;

FIG. 14 is a front view showing a high-profile external connection module;

FIG. 15 is a rear view showing the high-profile external connection module; and

FIG. 16 is a cross-sectional view taken along line XVI-XVI in FIG. 14.

### EMBODIMENTS OF THE INVENTION

### Description of Embodiments of the Present Disclosure

First, embodiments of the present disclosure will be described.

(1) The present disclosure is a power storage pack that includes a plurality of power storage modules, in which the plurality of power storage modules each include a power storage element group in which a plurality of power storage elements having electrode terminals are arranged side-by-side in an arrangement direction, and an external connection module that is electrically connected to the electrode terminals of the plurality of power storage elements, the external connection module includes a short bus bar for outputting power of the power storage element group, a long bus bar that is for outputting power of the power storage element group and is longer than the short bus bar with regard to the arrangement direction, and an insulating member for insulating and holding the short bus bar and the long bus bar, the insulating member includes a first unit for holding one end portion of the long bus bar and a second unit for holding another end portion of the long bus bar with regard to the arrangement direction, the first unit has a first overlapping portion, the second unit has a second overlapping portion, the first overlapping portion and the second overlapping portion have an overlapping margin and overlap each other along the arrangement direction, and a length of the overlapping margin in the arrangement direction is variable, and the plurality of power storage modules include a plurality of types of power storage modules to which a plurality of types of long bus bars having different lengths in the arrangement direction are attached.

A length of the insulating member in the arrangement direction can be changed by changing the length of the overlapping margin where the first overlapping portion and the second overlapping portion overlap each other with regard to the arrangement direction. Accordingly, the long bus bars having different lengths can be held by the insulating member without manufacturing components having different lengths. As a result, a plurality of types of components need not be manufactured in correspondence to long bus bars having different lengths, and thus it is possible to reduce the manufacturing cost of a power storage pack.

(2) It is preferable that an amount of change in the length of the overlapping margin with regard to the arrangement direction is more than or equal to a thickness of a power storage element with regard to the arrangement direction.

Because the amount of change in the length of the overlapping margin with regard to the arrangement direction is more than or equal to the thickness of the power storage element with regard to the arrangement direction, when the number of power storage elements is increased or reduced, it is possible to handle a change in the length of the power storage element group with regard to the arrangement direction. Accordingly, a plurality of types of components need not be manufactured in correspondence to long bus bars having different lengths, and thus it is possible to reduce the manufacturing cost of a power storage pack.

(3) It is preferable that the first unit or the second unit is provided with a step portion that is recessed in a direction that intersects with the arrangement direction, and the first overlapping portion and the second overlapping portion overlap each other in the step portion.

Because the first overlapping portion and the second overlapping portion overlap each other in the direction that intersects with the arrangement direction in the step portion, it is possible to inhibit the thickness of the insulating member from increasing in the direction that intersects with the arrangement direction.

(4) It is preferable that the long bus bar is wide in a width direction orthogonal to the arrangement direction, the long bus bar has a locking rib extending from a side edge extending in the arrangement direction in a direction that intersects with a plate surface of the long bus bar, and the first unit or the second unit has a locking claw for restricting separation of the long bus bar from the first unit or the second unit as a result of the locking claw being locked to the locking rib.

Because the long bus bar is provided with the locking rib, the long bus bar is unlikely to deform even if an external force is applied thereto. Thus, this configuration is particularly effective when the long bus bar is wide in the width direction orthogonal to the arrangement direction. Also, because the locking rib extends from the plate surface of the long bus bar, the length of the locking claw with regard to the direction that intersects with the plate surface of the long bus bar can be increased. This makes the locking claw easily undergo elastic deformation, and thus the long bus bar and the locking claw can be easily locked to each other.

(5) It is preferable that a wiring module is arranged on the power storage element group, the wiring module includes a plurality of bus bars connected to the electrode terminals of the plurality of power storage elements and an insulating protector for holding the plurality of bus bars, and the external connection module is arranged on a side opposite to the power storage element group with respect to the wiring module.

According to this configuration, power can be extracted from any point in the power storage element group, and the external connection module can be easily attached to the power storage element group.

(6) The present disclosure is an external connection module system that includes an external connection module that is electrically connected to a power storage element group in which a plurality of power storage elements are arranged side-by-side in an arrangement direction, in which the external connection module includes a short bus bar for outputting power of the power storage element group, a long bus bar that is for outputting power of the power storage element group and is longer than the short bus bar with regard to the arrangement direction, and an insulating member for insulating and holding the short bus bar and the long bus bar, the insulating member includes a first unit for holding one end portion of the long bus bar and a second unit for holding another end portion of the long bus bar, the first unit has a first overlapping portion, the second unit has a second overlapping portion, the first overlapping portion and the second overlapping portion have an overlapping margin and overlap each other along the arrangement direction, and a length of the overlapping margin in the arrangement direction is variable, and the long bus bar is selected from a plurality of types of long bus bars having different lengths in the arrangement direction.

A length of the insulating member in the arrangement direction can be changed by changing the length of the overlapping margin where the first overlapping portion and the second overlapping portion overlap each other with regard to the arrangement direction. Accordingly, the long bus bars having different lengths can be held by the insulating member without manufacturing components having different lengths. As a result, a plurality of types of components need not be manufactured in correspondence to long bus bars having different lengths, and thus it is possible to reduce the manufacturing cost of an external connection module.

### Details of Embodiments of the Present Disclosure

Hereinafter, embodiments of the present disclosure will be described. The present invention is not limited to these examples, and is defined by the claims, and all changes that come within the meaning and range of equivalency of the claims are intended to be embraced therein.

### Embodiment 1

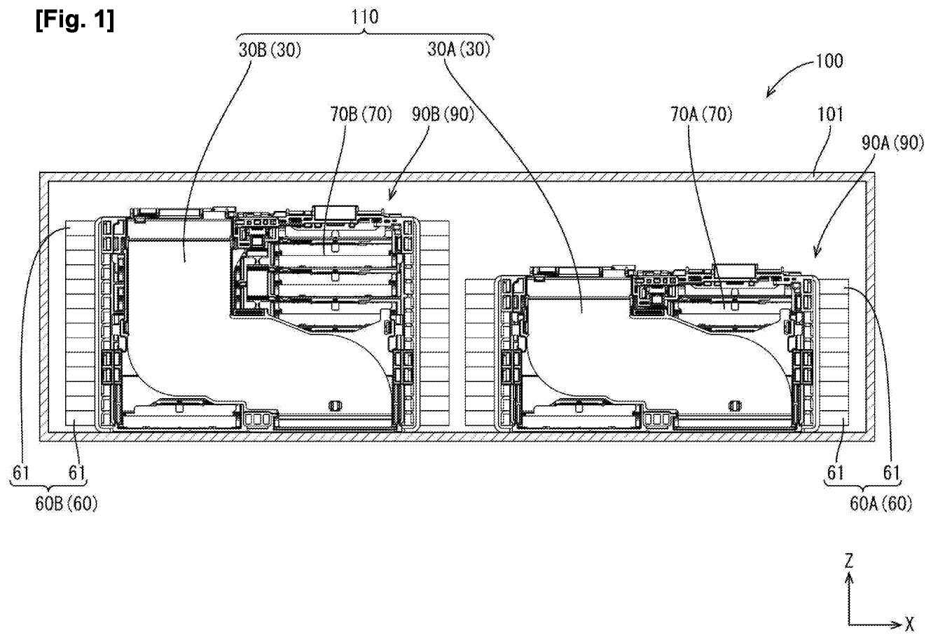

Embodiment 1 according to a power storage pack 100 to which the present disclosure is applied and an external connection module system 110 will be described with reference to FIGS. 1 to 16. The power storage pack 100 according to this embodiment includes a metal case 101 and a power storage module 90 housed in the case 101. The power storage module 90 includes a power storage element group 60 in which a plurality of power storage elements 61 are arranged side-by-side in the up-down direction (an example of an arrangement direction), a wiring module 70 attached to a front surface of the power storage element group 60, and an external connection module 30 attached to the front surface of the wiring module 70. Note that, in the following description, the terms up, front, and left refer to the directions respectively indicated by arrows Z, Y, and X. Also, reference signs may be given to only one member of a plurality of the same members, and reference signs may be omitted from the other same members.

### Power Storage Pack 100

As shown in FIG. 1, in the power storage pack 100, one or more power storage modules 90 are housed in a case 101 made of a conductive metal. In this embodiment, a low-profile power storage module 90A that is relatively low in the up-down direction, and a high-profile power storage module 90B that is higher than the low-profile power storage module 90A in the up-down direction are housed in the case 101. Any metal such as aluminum, an aluminum alloy, or a stainless steel can be selected as needed as a metal constituting the case 101.

### Low-Profile Power Storage Module 90A

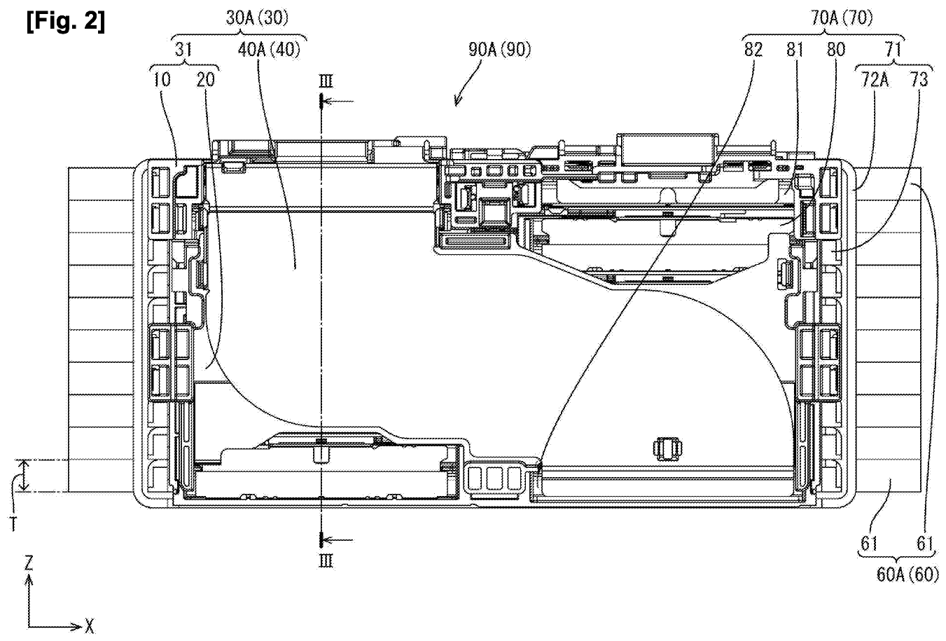

As shown in FIG. 2, the low-profile power storage module 90A includes a low-profile power storage element group 60A that is relatively low in the up-down direction, a low-profile wiring module 70A that is relatively low in the up-down direction, and a low-profile external connection module 30A that is relatively low in the up-down direction.

### Low-Profile Power Storage Element Group 60A

In the low-profile power storage element group 60A, a plurality (ten in this embodiment) power storage elements 61 are stacked on each other in the up-down direction and are arranged side-by-side. The power storage elements 61 each have a substantially rectangular parallelepiped shape that is flat in the up-down direction. Two electrode terminals 63 protruding frontward are provided at positions near right and left end portions on the front surface of the power storage element 61. One of the two electrode terminals 63 is a positive electrode, and the other electrode terminal 63 is a negative electrode. The electrode terminals 63 are made of relatively thin conductive metal plates. Any metal such as copper, a copper alloy, aluminum, or an aluminum alloy can be selected as appropriate as a metal constituting the electrode terminal 63. A metal constituting the positive electrode and a metal constituting the negative electrode may be the same or different from each other. In this embodiment, the positive electrode is made of aluminum or an aluminum alloy, and the negative electrode is made of copper or a copper alloy.

### Low-Profile Wiring Module 70A

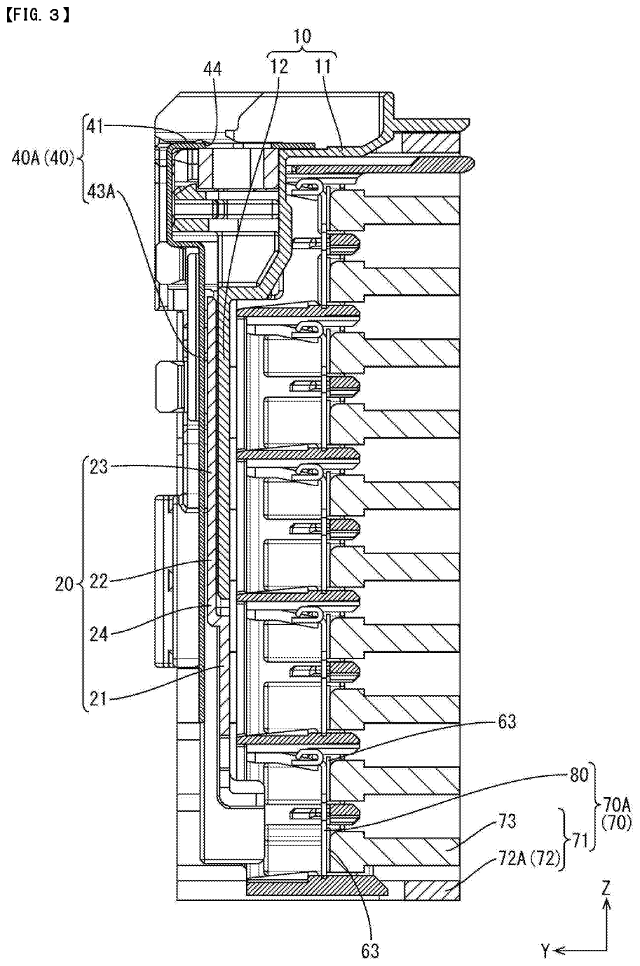

As shown in FIG. 2, the low-profile wiring module 70A is attached to the front surface of the low-profile power storage element group 60A. The low-profile wiring module 70A includes a plurality of bus bars 80 connected to the electrode terminals 63 of the power storage elements 61, and the insulating protector 71 in which the plurality of bus bars 80 are housed in an insulated state. The bus bars 80 are narrow and elongated in the right-left direction when viewed from the front. The electrode terminals 63, which have different polarities, of power storage elements 61 that are vertically arranged side-by-side are connected to each other by the bus bars 80 (see FIG. 3).

In this embodiment, one bus bar 80 is formed by joining two types of metals. A portion of the bus bar 80 that is connected to a positive electrode of the power storage element 61 is constituted by a metal that is the same as that of the positive electrode, and a portion of the bus bar 80 that is connected to a negative electrode of the power storage element 61 is constituted by a metal that is the same as that of the negative electrode. In this embodiment, a portion connected to the positive electrode of the power storage element 61 is constituted by aluminum or an aluminum alloy, and a portion connected to the negative electrode of the power storage element 61 is constituted by copper or a copper alloy. The bus bar 80 according to this embodiment is formed by vertically joining aluminum or an aluminum alloy, and copper or a copper alloy. A known method such as resistance welding, friction stir joining, or cold pressure welding can be used as a joining method.

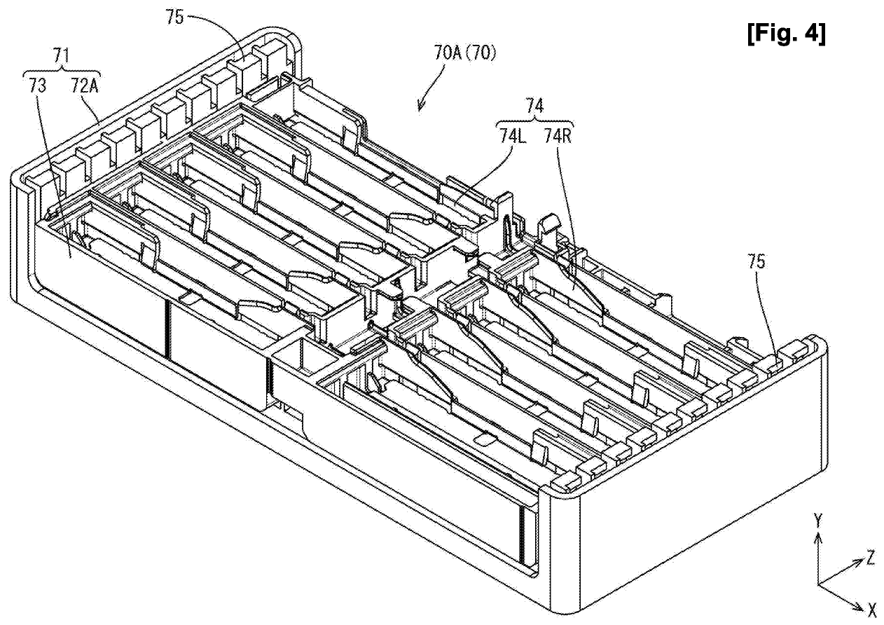

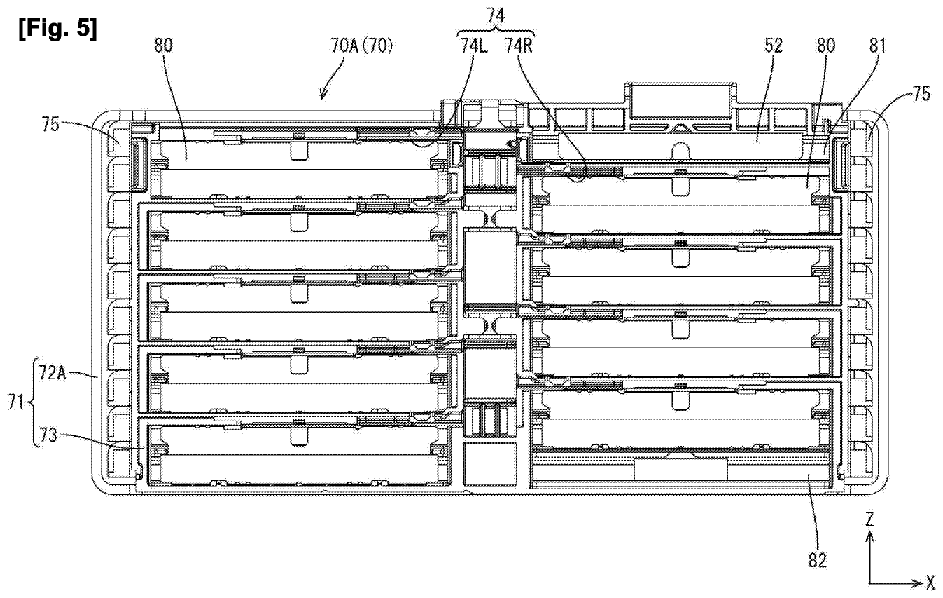

The insulating protector 71 is formed by injection molding an insulating synthetic resin. As shown in FIGS. 4 and 5, the insulating protector 71 includes a low-profile side frame 72A that is open in the front-rear direction, and a plurality of stacking units 73 housed in an inner portion of the low-profile side frame 72A. The plurality of stacking units 73 are stacked in the up-down direction on the inner side of the low-profile side frame 72A. The stacking units 73 have housing portions 74 in which the bus bars 80 are housed. Adjacent bus bars 80 are electrically insulated as a result of the bus bars 80 being housed in the housing portions 74.

The stacking units 73 each have a left housing portion 74L located on the left side, and a right housing portion 74R located on the right side. The right housing portion 74R is formed slightly upward of the left housing portion 74L. Accordingly, a plurality of power storage elements 61 that are arranged side-by-side in the up-down direction are connected to each other in series. Note that a configuration may be adopted in which a plurality of power storage elements 61 are connected in parallel to each other.

A first output bus bar 81 for outputting power of the low-profile power storage element group 60A to the outside is disposed in a right region of an upper edge of the low-profile wiring module 70A. The first output bus bar 81 is connected to a right electrode terminal 63 out of the electrode terminals 63 of the power storage elements 61 disposed in the uppermost step of the low-profile power storage element group 60A.

A second output bus bar 82 for outputting power of the low-profile power storage element group 60A to the outside is disposed in a right region of a lower edge of the low-profile wiring module 70A. The second output bus bar 82 is connected to a right electrode terminal 63 out of the electrode terminals 63 of the power storage elements 61 disposed in the lowermost step of the low-profile power storage element group 60A.

The polarity of the electrode terminal 63 connected to the first output bus bar 81 is different from the polarity of the electrode terminal 63 connected to the second output bus bar 82. That is, one output bus bar is connected to the positive electrode, and the other output bus bar is connected to the negative electrode.

### Low-Profile External Connection Module 30A

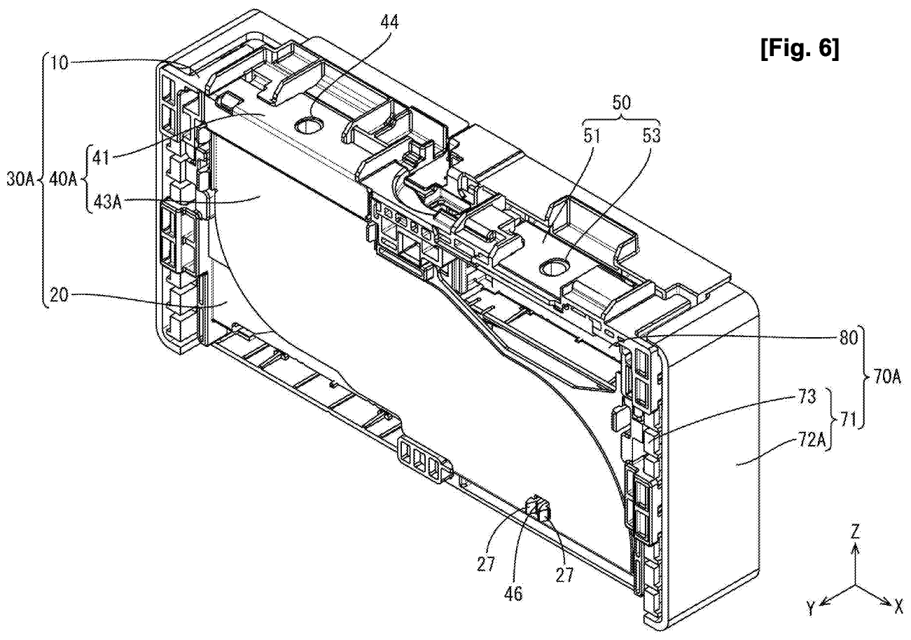

As shown in FIG. 6, the low-profile external connection module 30A is attached to the front surface of the low-profile wiring module 70A. The low-profile external connection module 30A includes the first unit 10 located on an upper side, the second unit 20 located on an lower side, a short bus bar 50 held on the right side of the first unit 10, and a low-profile side long bus bar 40A whose upper end portion is held on the left side of the first unit 10 and lower end portion is held on the right side of the second unit 20. The first unit 10 and the second unit 20 are linked together by the low-profile side long bus bar 40A. The insulating member 31 is constituted by the first unit 10 and the second unit 20, the short bus bar 50 and the low-profile side long bus bar 40A being kept insulated by the insulating member 31.

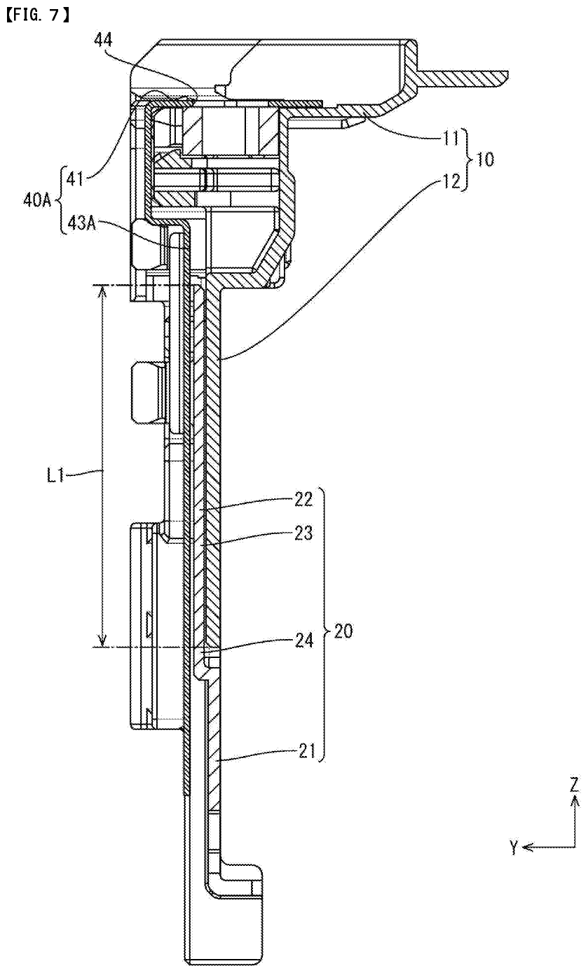

The first unit 10 is formed by injection molding an insulating synthetic resin. As shown in FIG. 7, the first unit 10 has an upper wall 11 that is located at the upper end portion thereof and extends in the right-left direction, and the first overlapping portion 12 extending downward from the left side of the rear edge of the upper wall 11. The width of the upper wall 11 in the right-left direction is slightly smaller than the width of the wiring module 70 in the right-left direction. The width of the upper wall 11 in the front-rear direction is slightly larger than the width of the wiring module 70 in the front-rear direction. The first overlapping portion 12 is formed in a plate shape that is flat in the front-rear direction, and has a substantially rectangular shape when viewed in the front-rear direction.

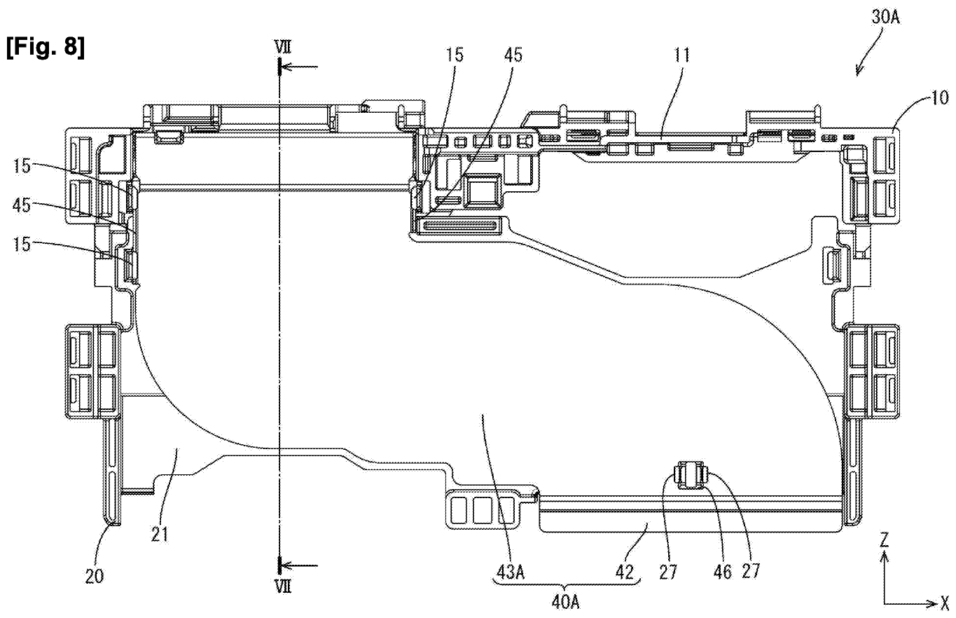

As shown in FIG. 8, the second unit 20 is formed by injection molding an insulating synthetic resin. The second unit 20 has a partition 21 disposed such that a wall surface thereof is oriented in the front-rear direction. The partition 21 is configured to separate the low-profile side long bus bar 40A and the bus bars 80 disposed in the wiring module 70 in a state in which the low-profile external connection module 30A is attached to the low-profile wiring module 70A. The width of the partition 21 in the right-left direction is equal to or slightly larger than a region of the wiring module 70 that is provided with the housing portions 74.

The left portion of the partition 21 serves as the second overlapping portion 22 that overlaps a front portion of the first overlapping portion 12. As shown in FIG. 7, the first overlapping portion 12 and the second overlapping portion 22 have an overlapping margin 23 extending in the up-down direction and overlap each other in the front-rear direction. The partition 21 is provided with the step portion 24 that is recessed frontward, in a substantially two thirds of a region thereof extending from the upper end portion with regard to the up-down direction. As will be described later, a portion of the step portion 24 that overlaps the first overlapping portion 12, and a portion of the step portion 24 that may overlap the first overlapping portion 12 serve as the second overlapping portion 22.

The depth of the step portion 24 in the front-rear direction is equal to or slightly larger than the thickness of the first overlapping portion 12 of the first unit 10 in the front-rear direction. Accordingly, the rear surface of the first overlapping portion 12 is configured not to protrude rearward from the rear surface of the partition 21 in a state in which the first overlapping portion 12 and the second overlapping portion 22 overlap each other in the front-rear direction.

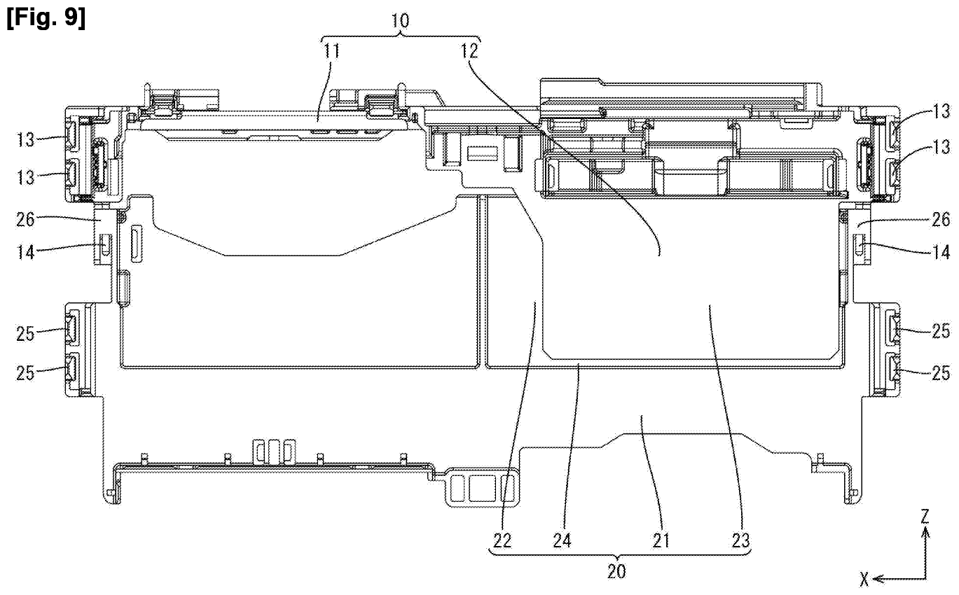

As shown in FIG. 9, the right and left side edges of the first unit 10 are provided with first locking claws 13 that protrude rearward. The right and left side edges of the second unit 20 are provided with second locking claws 25 that protrude rearward. The first unit 10, the second unit 20, and the low-profile wiring module 70A can be integrally assembled as a result of the first locking claws 13 and the second locking claws 25 being elastically locked to locking receiving portions 75 formed in the low-profile wiring module 70A. The locking receiving portions 75 that have the same shape and the same size are arranged in the low-profile wiring module 70A side-by-side in the up-down direction.

As shown in FIG. 9, right and left end portions of the first unit 10 are provided with rod-shaped guide portions 14 that extend downward. Right and left end portions of the second unit 20 are provided with tubular guide receiving portions 26 that extend in the up-down direction and are open upward. As a result of the guide portions 14 being inserted into the guide receiving portions 26, the guide portions 14 come into contact with the inner walls of the guide receiving portions 26. The first unit 10 and the second unit 20 are positioned accordingly.

### Short Bus Bar 50

The short bus bar 50 is formed by pressing a metal plate material into a predetermined shape. Any metal such as copper, a copper alloy, aluminum, or an aluminum alloy can be selected as a metal constituting the short bus bar 50.

The short bus bar 50 has a short side external connection portion 51 (see FIG. 6) disposed along the upper surface of the upper wall 11 of the first unit 10, and a short side bus bar connection portion 52 (see FIG. 5) disposed along the first output bus bar 81 of the low-profile wiring module 70A. Although not shown in detail, the short side external connection portion 51 and the short side bus bar connection portion 52 are linked together and are electrically connected to each other. The height of the short bus bar 50 in the up-down direction is set slightly larger than the thickness of the upper wall 11 of the first unit 10 in the up-down direction.

As shown in FIG. 6, the short side external connection portion 51 is provided with a through-hole 53 passing through the short side external connection portion 51 in the up-down direction. A bolt (not shown) is screwed into the through-hole 53, and thereby the short side external connection portion 51 is electrically connected to an external terminal of an external circuit (not shown).

As shown in FIG. 5, the short side bus bar connection portion 52 is disposed along the front surface of the first output bus bar 81, and is connected to the first output bus bar 81. Although there is no limitation on a method for connecting the short side bus bar connection portion 52 and the first output bus bar 81 to each other, the short side bus bar connection portion 52 and the first output bus bar 81 are connected to each other through welding such as laser welding or ultrasonic welding, soldering, brazing and welding such as brazing, or the like, for example.

### Low-Profile Side Long Bus Bar 40A

The low-profile side long bus bar 40A is formed by pressing a metal plate material into a predetermined shape. Any metal such as copper, a copper alloy, aluminum, or an aluminum alloy can be selected as a metal constituting the low-profile side long bus bar 40A. The low-profile side long bus bar 40A and the short bus bar 50 may be made of the same metal, or may be made of different metals.

The low-profile side long bus bar 40A has a long side external connection portion 41 (see FIG. 7) disposed along the upper surface of the upper wall 11 of the first unit 10, a long side bus bar connection portion 42 (see FIG. 8) disposed along the second output bus bar 82 of the low-profile wiring module 70A, and a low-profile side intermediate portion 43A for connecting the long side external connection portion 41 and the short side bus bar connection portion 52 (see FIGS. 7 and 8).

The long side external connection portion 41 is provided with a through-hole 44 passing through the long side external connection portion 41 in the up-down direction. A bolt (not shown) is screwed into the through-hole 44, and thereby the long side external connection portion 41 is electrically connected to an external terminal of an external circuit (not shown).

The long side bus bar connection portion 42 is disposed along the front surface of the second output bus bar 82, and is connected to the second output bus bar 82. Although there is no limitation on the method for connecting the long side bus bar connection portion 42 and the second output bus bar 82 to each other, the long side bus bar connection portion 42 and the second output bus bar 82 are connected to each other through welding such as laser welding or ultrasonic welding, soldering, brazing and welding such as brazing, or the like, for example.

The low-profile side intermediate portion 43A extends in the up-down direction, and connects a front edge of the long side external connection portion 41 and a front edge of the long side bus bar connection portion 42. The low-profile side intermediate portion 43A is formed in a rounded S-shape that extends from a diagonally upper left portion to a diagonally lower right portion, when viewed from the front.

The width of the long side external connection portion 41 in the right-left direction and the width of the long side bus bar connection portion 42 in the right-left direction are set to be substantially the same as the width of the bus bars 80 in the right-left direction attached to the low-profile wiring module 70A. The width thereof in a direction orthogonal to a direction in which the low-profile side intermediate portion 43A extends is set to be substantially the same as the width of the bus bars 80 in the right-left direction attached to the low-profile wiring module 70A. “Substantially the same” includes a case where the width of the long side external connection portion 41 in the right-left direction, the width of the long side bus bar connection portion 42 in the right-left direction, and the width thereof in a direction orthogonal to the direction in which the low-profile side intermediate portion 43A extends, and the width of the bus bars 80 in the right-left direction attached to the low-profile wiring module 70A are the same, or are different from each other to an extent that these widths may be recognized as the same. Accordingly, the low-profile side long bus bar 40A is wide in the right-left direction when viewed from the front.

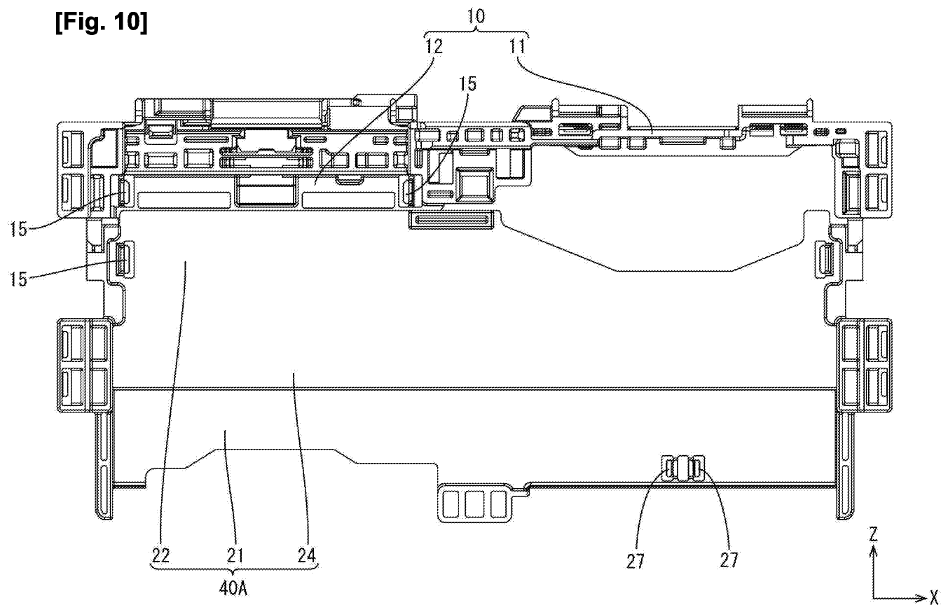

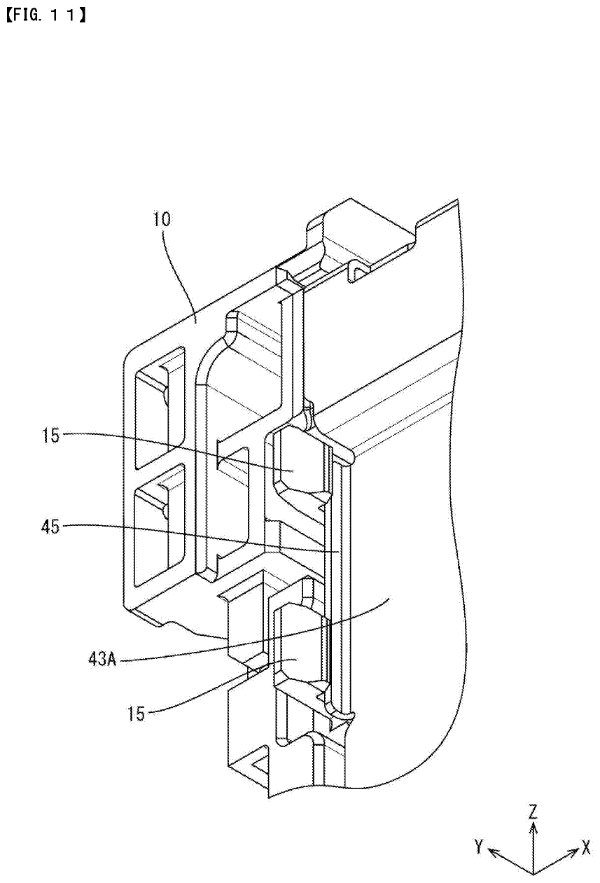

As shown in FIG. 8, the right and left side edges of the low-profile side intermediate portion 43A located in a portion extending downward from the long side external connection portion 41 are provided with locking ribs 45 extending frontward from the plate surface of the low-profile side intermediate portion 43A. As shown in FIG. 10, the first unit 10 is provided with plate-shaped first locking claws 15 (an example of the locking claw) that protrude frontward. The first locking claws 15 are disposed outward of the locking ribs 45 in the right-left direction. The first locking claws 15 can elastically deform in the right-left direction. The low-profile side long bus bar 40A is held by the first unit 10 in a locked state as a result of the first locking claws 15 being locked to the locking ribs 45 from the front (see FIG. 11).

A portion of the low-profile side intermediate portion 43A that extends upward from the long side bus bar connection portion 42 is provided with a locking hole 46 passing through the low-profile side intermediate portion 43A, near an intermediate position in the right-left direction. The second unit 20 is provided with plate-shaped second locking claws 27 that extend frontward, at positions corresponding to the locking hole 46. The second locking claws 27 can elastically deform in the right-left direction. The low-profile side long bus bar 40A is held by the second unit 20 in a locked state as a result of the second locking claws 27 being locked to a hole edge of the locking hole 46 from the front in a state in which the second locking claws 27 are inserted into the locking hole 46.

### High-Profile Power Storage Module 90B

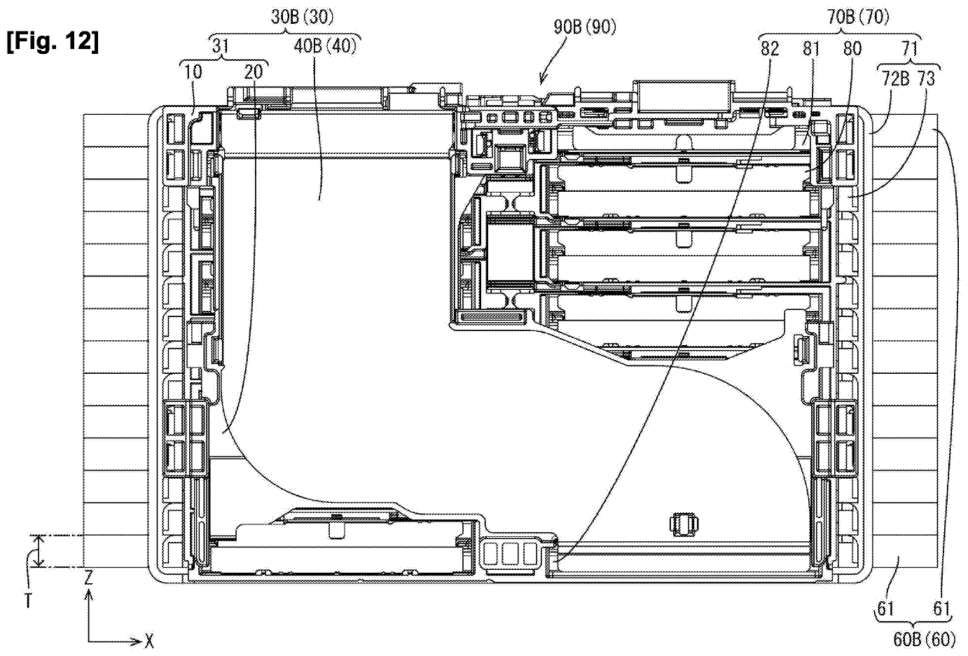

As shown in FIG. 12, the high-profile power storage module 90B includes a high-profile power storage element group 60B that is relatively high in the up-down direction, a high-profile wiring module 70B that is relatively high in the up-down direction, and a high-profile external connection module 30B that is relatively high in the up-down direction.

### High-Profile Power Storage Element Group 60B

In the high-profile power storage element group 60B, a plurality (fourteen in this embodiment) power storage elements 61 are stacked on each other in the up-down direction and are arranged side-by-side. The power storage elements 61 that constitute the high-profile power storage element group 60B are the same as the power storage elements 61 that constitute the low-profile power storage element group 60A, and thus redundant descriptions will be omitted.

### High-Profile Wiring Module 70B

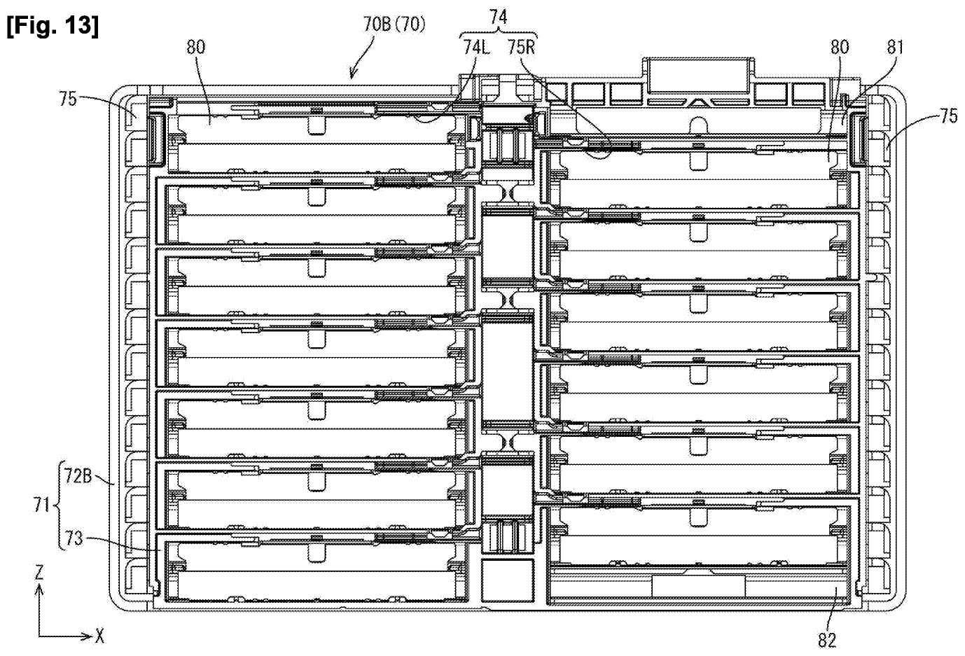

As shown in FIG. 13, the high-profile wiring module 70B includes a plurality of bus bars 80 connected to the electrode terminals 63 of the power storage elements 61, and the insulating protector 71 in which the plurality of bus bars 80 are housed in an insulated state. The bus bars 80 are narrow and elongated in the right-left direction when viewed from the front. The electrode terminals 63, which have different polarities, of power storage elements 61 that are vertically arranged side-by-side are connected to each other by the bus bars 80.

The plurality of bus bars 80 that constitute the high-profile wiring module 70B are the same as the plurality of bus bars 80 that constitute the low-profile wiring module 70A, and thus redundant descriptions will be omitted.

The insulating protector 71 includes a high-profile side frame 72B that is open in the front-rear direction, and a plurality of stacking units 73 housed in an inner portion of the high-profile side frame 72B. The plurality of stacking units 73 that constitute the high-profile wiring module 70B are the same as the plurality of stacking units 73 that constitute the low-profile wiring module 70A except that the number of stacking units is changed, and thus redundant descriptions will be omitted.

The High-Profile Side Frame 72B is the Same as the Low-Profile Side frame 72A, except that the length of the high-profile side frame 72B in the up-down direction is larger than that of the low-profile side frame 72A in the up-down direction, and thus redundant descriptions will be omitted.

### High-Profile External Connection Module 30B

As shown in FIG. 12, the high-profile external connection module 30B is attached to the front surface of the high-profile wiring module 70B. The high-profile external connection module 30B includes the first unit 10 located on an upper side, the second unit 20 located on an lower side, the short bus bar 50 held on the right side of the first unit 10, and a high-profile side long bus bar 40B whose upper end portion is held on the left side of the first unit 10 and lower end portion is held on the right side of the second unit 20. The first unit 10 and the second unit 20 are linked together by the high-profile side long bus bar 40B. The insulating member 31 is constituted by the first unit 10 and the second unit 20, the short bus bar 50 and the low-profile side long bus bar 40A being kept insulated by the insulating member 31.

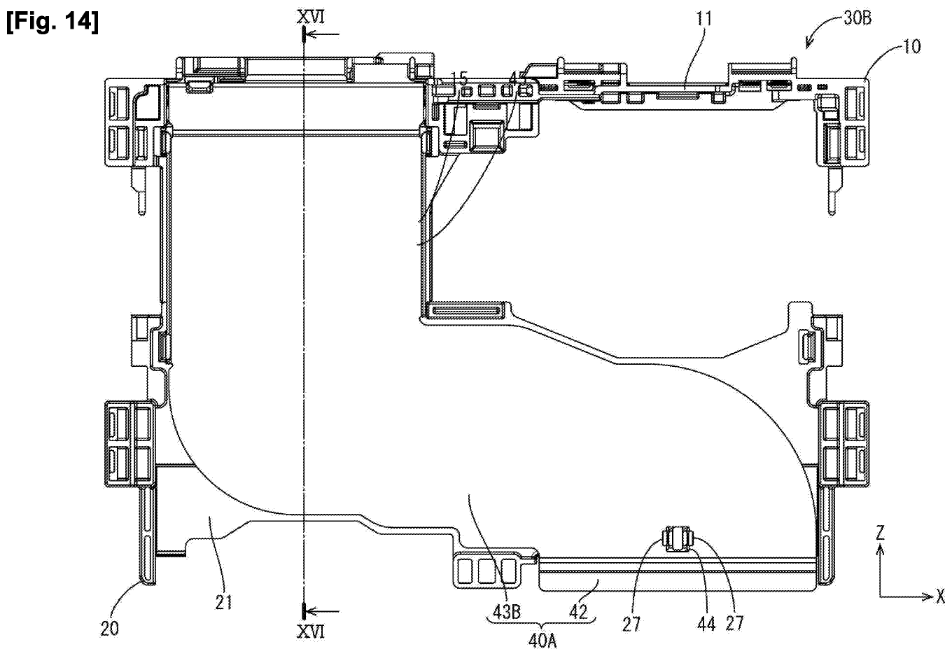

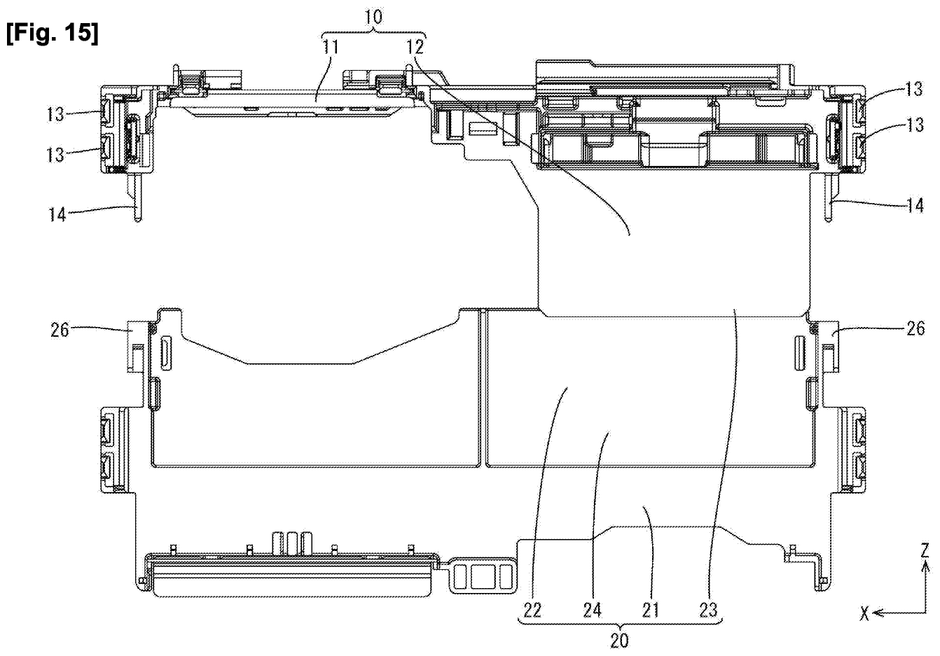

As shown in FIGS. 14 and 15, in the high-profile external connection module 30B, the guide portion 14 of the first unit 10 and the guide receiving portion 26 of the second unit 20 are located away from each other. The first unit 10 and the second unit 20 of the high-profile external connection module 30B are the same as the first unit 10 and the second unit 20 of the low-profile connection module, except for the above-described configurations, and thus redundant descriptions will be omitted.

The short bus bar 50 of the high-profile external connection module 30B is the same as the short bus bar 50 of the low-profile external connection module 30A, and thus redundant descriptions will be omitted.

### High-Profile Side Long Bus Bar 40B

The high-profile side long bus bar 40B is formed by pressing a metal plate material into a predetermined shape. Any metal such as copper, a copper alloy, aluminum, or an aluminum alloy can be selected as a metal constituting the high-profile side long bus bar 40B. The high-profile side long bus bar 40B and the short bus bar 50 may be made of the same metal, or may be made of different metals.

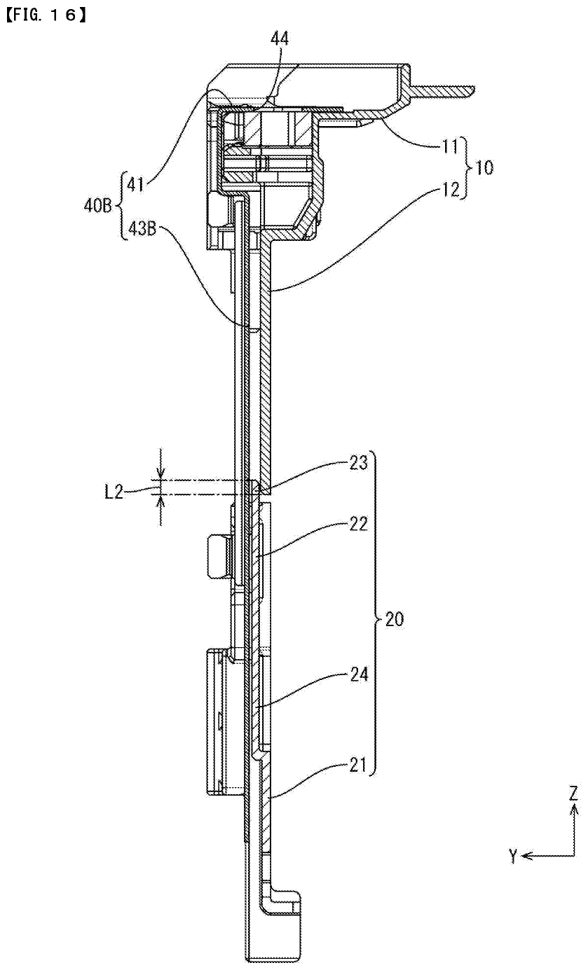

The high-profile side long bus bar 40B has a long side external connection portion 41 (see FIG. 16) disposed along the upper surface of the upper wall 11 of the first unit 10, a long side bus bar connection portion 42 (see FIG. 15) disposed along a second output bus bar 82 of the low-profile wiring module 70A, and a high-profile side intermediate portion 43B for connecting the long side external connection portion 41 and the short side bus bar connection portion 52 (see FIGS. 15 and 16).

As shown in FIG. 15, the long side external connection portion 41 is provided with a through-hole 44 passing through the long side external connection portion 41 in the up-down direction. A bolt (not shown) is screwed into the through-hole 44, and thereby the long side external connection portion 41 is electrically connected to an external terminal of an external circuit (not shown).

As shown in FIG. 12, the long side bus bar connection portion 42 is disposed along the front surface of the second output bus bar 82, and is connected to the second output bus bar 82. Although there is no limitation on a method for connecting the long side bus bar connection portion 42 and the second output bus bar 82 to each other, the long side bus bar connection portion 42 and the second output bus bar 82 are connected to each other through welding such as laser welding or ultrasonic welding, soldering, brazing and welding such as brazing, or the like, for example.

The high-profile side intermediate portion 43B extends in the up-down direction, and connects a front edge of the long side external connection portion 41 and a front edge of the long side bus bar connection portion 42.

The width of the long side external connection portion 41 in the right-left direction and the width of the long side bus bar connection portion 42 in the right-left direction are set to be substantially the same as the width of the bus bar 80 in the right-left direction attached to the high-profile wiring module 70B. The width thereof in a direction orthogonal to a direction in which the high-profile side intermediate portion 43B extends is set to be substantially the same as the width of the bus bars 80 in the right-left direction attached to the high-profile wiring module 70B. “Substantially the same” includes a case where the width of the long side external connection portion 41 in the right-left direction, the width of the long side bus bar connection portion 42 in the right-left direction, and the width thereof in a direction orthogonal to the direction in which the high-profile side intermediate portion 43B extends, and the width of the bus bars 80 in the right-left direction attached to the high-profile wiring module 70B are the same, or are different from each other in an extent that these widths may be recognized as the same. Accordingly, the high-profile side long bus bar 40B is wide in the right-left direction when viewed from the front.

The right and left side edges of the high-profile side intermediate portion 43B located in a portion extending downward from the long side external connection portion 41 are provided with locking ribs 45 extending frontward from the plate surface of the high-profile side intermediate portion 43B. The first unit 10 is provided with plate-shaped first locking claws 15 that protrude frontward. The first locking claws 15 are disposed outward of the locking ribs 45 in the right-left direction. The first locking claws 15 can elastically deform in the right-left direction. The high-profile side long bus bar 40B is held by the first unit 10 in a locked state as a result of the first locking claws 15 being locked to the locking ribs 45 from the front.

The length of a portion of the high-profile side intermediate portion 43B that extends downward from the long side external connection portion 41 in the up-down direction is set larger than the length of a portion of the high-profile side intermediate portion 43B that extends downward from the long side external connection portion 41 in the up-down direction. Accordingly, the high-profile side long bus bar 40B is also longer than the low-profile side long bus bar 40A with regard to the up-down direction.

A portion of the high-profile side intermediate portion 43B that extends upward from the long side bus bar connection portion 42 is provided with a locking hole 46 passing through the low-profile side intermediate portion 43A, near an intermediate position in the right-left direction. The second unit 20 is provided with plate-shaped second locking claws 27 that extend frontward, at positions corresponding to the locking hole 46. The second locking claws 27 can elastically deform in the right-left direction. The high-profile side long bus bar 40B is held by the second unit 20 in a locked state as a result of the second locking claws 27 being locked to a hole edge of the locking hole 46 from the front in a state in which the second locking claws 27 are inserted into the locking hole 46.

### Length of Overlapping Margin 23

The length of the overlapping margin 23 in the up-down direction where the first overlapping portion 12 of the first unit 10 and the second overlapping portion 22 of the second unit 20 overlap each other is variable. As shown in FIGS. 7 and 16, in this embodiment, the length of the overlapping margin 23 is variable at least between a length L1 of the overlapping margin 23 between the first unit 10 and the second unit 20 in the up-down direction in the low-profile external connection module 30A and a length L2 of the overlapping margin 23 between the first unit 10 and the second unit 20 in the up-down direction in the high-profile external connection module 30B.

The overlapping margin 23 refers to a region where the first overlapping portion 12 and the second overlapping portion 22 overlap each other in the front-rear direction. It is presumed that the first overlapping portion 12 and the second overlapping portion 22 include portions that overlap each other in the front-rear direction and portions that may overlap each other. Although, in the high-profile external connection module 30B, the first overlapping portion 12 and the second overlapping portion 22 overlap each other in the front-rear direction within the length L2 in the up-down direction, it is presumed that the first overlapping portion 12 and the second overlapping portion 22 include the range of the length L1 of the overlapping margin 23 in the up-down direction at least in the low-profile external connection module 30A, for example.

The second overlapping portion 22 refers to a portion of the step portion 24 that overlaps the first overlapping portion 12, and a portion of the step portion 24 that may overlap the first overlapping portion 12. The entire region of the step portion 24 may serve as the second overlapping portion 22, or a portion of the step portion 24 may serve as the second overlapping portion 22, depending on settings for the dimensions of the low-profile external connection module 30A in the up-down direction, for example. In other words, the second overlapping portion 22 is specified as a predetermined region depending on the settings of the low-profile external connection module 30A.

A difference between the length L1 of the overlapping margin 23 in the low-profile external connection module 30A and the length L2 of the overlapping margin 23 in the high-profile external connection module 30B is larger than the thickness of the power storage element 61 in the up-down direction. In this embodiment, the difference between the length L1 of the overlapping margin 23 in the low-profile external connection module 30A and the length L2 of the overlapping margin 23 in the high-profile external connection module 30B is four times a thickness T of the power storage element 61 in the up-down direction. Accordingly, the high-profile power storage module 90B can hold four more power storage elements 61 than the low-profile power storage module 90A can hold.

Because the first unit 10 and the second unit 20 have the overlapping margin 23 and overlap each other, the low-profile side long bus bar 40A and the bus bar 80 of the low-profile wiring module 70A are insulated by the first overlapping portion 12 and the second overlapping portion 22. Similarly, the high-profile side long bus bar 40B and the bus bar 80 of the high-profile wiring module 70B are also insulated by the first overlapping portion 12 and the second overlapping portion 22.

### Number of Power Storage Elements 61

In the power storage element group 60, relative positions of the first output bus bar 81 and the second output bus bar 82 are determined by whether the number of power storage elements 61 included in the power storage element group 60 is an even number or an odd number. In this embodiment, the low-profile power storage element group 60A includes ten power storage elements 61, and the high-profile power storage element group 60B includes fourteen power storage elements 61. If the number of power storage elements 61 included in the power storage element group 60 is an even number, for example, the first output bus bar 81 is disposed in an upper right portion of the power storage element group 60, and the second output bus bar 82 is disposed in a lower right portion of the power storage element group 60. On the other hand, if the number of power storage elements 61 included in the power storage element group 60 is an odd number, for example, the first output bus bar 81 is disposed in the upper right portion of the power storage element group 60, and the second output bus bar 82 is disposed in the lower left portion of the power storage element group 60.

It is preferable that, in order for the low-profile external connection module 30A and the high-profile external connection module 30B to share the first unit 10 and the second unit 20, the relative positions of the first output bus bar 81 and the second output bus bar 82 do not change even if the number of power storage elements 61 is increased or reduced.

In this embodiment, the low-profile power storage element group 60A includes ten power storage elements 61, and the high-profile power storage element group 60B includes fourteen power storage elements 61. Because both the number of power storage elements 61 included in the low-profile power storage element group 60A and the number of power storage elements 61 included in the high-profile power storage element group 60B are even numbers in this manner, the relative positions of the first output bus bar 81 and the second output bus bar 82 in the low-profile power storage element group 60A and the relative positions of the first output bus bar 81 and the second output bus bar 82 in the high-profile power storage element group 60B do not change.

If the number of power storage elements 61 included in the power storage element group 60 is an odd number, the number of power storage elements 61 included in the power storage element group 60 is always an odd number even if the number of power storage elements 61 is changed by increasing or reducing an even number of power storage elements 61. Thus, it is possible to maintain the relative positions of the first output bus bar 81 and the second output bus bar 82.

### Manufacturing Process of Embodiment

Next, an example of a process for manufacturing the power storage pack 100 according to this embodiment will be described. The process for manufacturing the power storage pack 100 is not limited to the description below.

### Low-Profile Power Storage Module 90A

The low-profile power storage element group 60A is formed by stacking ten power storage elements 61 in the up-down direction and arranging the ten power storage elements 61 side-by-side. The bus bars 80 are housed in the left housing portions 74L and the right housing portions 74R of the stacking units 73. A predetermined number of stacking units 73 are attached to the inside of the low-profile side frame 72A. Accordingly, the low-profile wiring module 70A is formed.

The low-profile wiring module 70A is attached to the front surface of the low-profile power storage element group 60A. The bus bars 80 and the electrode terminals 63 of the power storage elements 61 are connected to each other through laser welding, for example.

The short bus bar 50 is attached to the upper wall 11 of the first unit 10. The first unit 10 and the low-profile side long bus bar 40A are attached to each other as a result of the first locking portions of the first unit 10 and the locking ribs 45 of the low-profile side long bus bar 40A being locked to each other. The second unit 20 and the low-profile side long bus bar 40A are attached to each other as a result of the second locking portions of the second unit 20 and the hole edge of the locking hole 46 of the low-profile side long bus bar 40A being locked to each other. Accordingly, the low-profile external connection module 30A is formed.

The low-profile external connection module 30A is attached to the front surface of the low-profile wiring module 70A as a result of the first locking claws 13 of the first unit 10 and the second locking claws 25 of the second unit 20 being locked to the locking receiving portions 75 of the low-profile wiring module 70A.

The short side bus bar connection portion 52 of the short bus bar 50 and the first output bus bar 81 are connected to each other through laser welding, for example. The long side bus bar connection portion 42 of the low-profile side long bus bar 40A and the second output bus bar 82 are connected to each other through laser welding, for example. Accordingly, the low-profile power storage module 90A is complete.

### High-Profile Power Storage Module 90B

The high-profile power storage element group 60B is formed by stacking fourteen power storage elements 61 in the up-down direction and arranging the fourteen power storage elements 61 side-by-side. The bus bars 80 are housed in the left housing portions 74L and the right housing portions 74R of the stacking units 73. A predetermined number of stacking units 73 are attached to the inside of the high-profile side frame 72B. Accordingly, the high-profile wiring module 70B is formed.

The high-profile wiring module 70B is attached to the front surface of the high-profile power storage element group 60B. The bus bars 80 and the electrode terminals 63 of the power storage elements 61 are connected to each other through laser welding, for example.

The short bus bar 50 is attached to the upper wall 11 of the first unit 10. The first unit 10 and the high-profile side long bus bar 40B are attached to each other as a result of the first locking portions of the first unit 10 and the locking ribs 45 of the high-profile side long bus bar 40B being locked to each other. The second unit 20 and the high-profile side long bus bar 40B are attached to each other as a result of the second locking claws 27 of the second unit 20 and the hole edge of the locking hole 46 of the high-profile side long bus bar 40B being locked to each other. Accordingly, the high-profile external connection module 30B is formed.

The high-profile external connection module 30B is attached to the front surface of the high-profile wiring module 70B as a result of the first locking claws 13 of the first unit 10 and the second locking claws 25 of the second unit 20 being locked to the locking receiving portions 75 of the high-profile wiring module 70B.

The short side bus bar connection portion 52 of the short bus bar 50 and the first output bus bar 81 are connected to each other through laser welding, for example. The long side bus bar connection portion 42 of the low-profile side long bus bar 40A and the second output bus bar 82 are connected to each other through laser welding, for example. Accordingly, the high-profile power storage module 90B is complete.

The low-profile power storage module 90A and the high-profile power storage module 90B are housed in the metal case 101, and the low-profile power storage module 90A and the high-profile power storage module 90B are connected to each other by a wiring member (not shown). Accordingly, the power storage pack 100 is complete.

### Effects of the Embodiment

Next, effects of this embodiment will be described. This embodiment is the power storage pack 100 that includes the low-profile power storage module 90A and the high-profile power storage module 90B, in which the low-profile power storage module 90A and the high-profile power storage module 90B each include the power storage element group 60 in which a plurality of power storage elements 61 are arranged side-by-side in the arrangement direction, and the external connection module 30 that is electrically connected to the plurality of power storage elements 61, the external connection module 30 includes the short bus bar 50 for outputting power of the power storage element group 60, the long bus bar 40 that is for outputting power of the power storage element group 60 and is longer than the short bus bar 50 with regard to the arrangement direction, and the insulating member 31 for insulating and holding the short bus bar 50 and the long bus bar 40, the insulating member 31 includes the first unit 10 for holding one end portion of the long bus bar 40 and the second unit 20 for holding the other end portion of the long bus bar 40 with regard to the arrangement direction, the first unit 10 includes the first overlapping portion 12, the second unit 20 includes the second overlapping portion 22, the first overlapping portion 12 and the second overlapping portion 22 have the overlapping margin 23 and overlap each other along the arrangement direction, the length of the overlapping margin 23 in the arrangement direction is variable, the low-profile side long bus bar 40A having a short length in the arrangement direction is attached to the low-profile power storage module 90A, and the high-profile side long bus bar 40B having a long length in the arrangement direction is attached to the high-profile power storage module 90B.

The length of the insulating member 31 in the arrangement direction can be changed by changing the length of the overlapping margin 23 where the first overlapping portion 12 and the second overlapping portion 22 overlap each other with regard to the arrangement direction. Accordingly, the long bus bars 40 having different lengths can be held by the insulating member 31 without manufacturing components having different lengths. As a result, a plurality of types of components need not be manufactured in correspondence to the long bus bars 40 having different lengths, and thus it is possible to reduce the manufacturing cost of the power storage pack 100.

According to this embodiment, the amount of change in the length of the overlapping margin 23 with regard to the arrangement direction is more than or equal to the thickness of the power storage element 61 with regard to the arrangement direction.

Because the amount of change in the length of the overlapping margin 23 with regard to the arrangement direction is more than or equal to the thickness of the power storage element 61 with regard to the arrangement direction, when the number of power storage elements 61 is increased or reduced, it is possible to handle a change in the length of the power storage element group 60 with regard to the arrangement direction. Accordingly, a plurality of types of components need not be manufactured in correspondence to the long bus bars 40 having different lengths, and thus it is possible to reduce the manufacturing cost of the power storage pack 100.

According to this embodiment, the second unit 20 is provided with the step portion 24 that is recessed in a direction that intersects with the arrangement direction, and the first overlapping portion 12 and the second overlapping portion 22 overlap each other in the step portion 24.

Because the first overlapping portion 12 and the second overlapping portion 22 overlap each other in the direction that intersects with the arrangement direction in the step portion 24, it is possible to inhibit the thickness of the insulating member 31 from increasing in the direction that intersects with the arrangement direction.

According to this embodiment, the high-profile side long bus bar 40B and the low-profile side long bus bar 40A are wide in the width direction orthogonal to the arrangement direction, and the high-profile side long bus bar 40B and the low-profile side long bus bar 40A have the locking ribs 45 that extend, from side edges extending in the arrangement direction, in a direction that intersects with the plate surfaces of the high-profile side long bus bar 40B and the low-profile side long bus bar 40A, and the first unit 10 has the first locking claws 15 for restricting separation of the high-profile side long bus bar 40B and the low-profile side long bus bar 40A from the first unit 10 as a result of the first locking claws 15 being locked to the locking ribs 45.

Because the high-profile side long bus bar 40B and the short-profile side long bus bar 40A are provided with the locking ribs 45, the high-profile side long bus bar 40B and the short-profile side long bus bar 40A are unlikely to deform even if an external force is applied thereto. Thus, this configuration is particularly effective when, as with this embodiment, the high-profile side long bus bar 40B and the short-profile side long bus bar 40A are wide in the width direction orthogonal to the arrangement direction. Also, because the locking ribs 45 extend from the plate surfaces of the high-profile side long bus bar 40B and the short-profile side long bus bar 40A, the length of the first locking claws 15 in the front-rear direction can be increased. This makes the first locking claws 15 easily undergo elastic deformation, and thus the high-profile side long bus bar 40B and the short-profile side long bus bar 40A, and the first locking claws 15 can be easily locked to each other.

According to this embodiment, the wiring module 70 is arranged on the power storage element group 60, and the wiring module 70 includes a plurality of bus bars 80 connected to the electrode terminals 63 of the plurality of power storage elements 61 and the insulating protector 71 for holding the plurality of bus bars 80, and the external connection module 30 is arranged on a side opposite to the power storage element group 60 with respect to the wiring module 70.

According to this configuration, power can be extracted from any point in the power storage element group 60, and the external connection module 30 can be easily attached to the power storage element group 60.

This embodiment is the external connection module system 110 that includes the external connection module 30 that is electrically connected to the power storage element group 60 in which a plurality of power storage elements 61 are arranged side-by-side in the arrangement direction, in which the external connection module 30 includes the short bus bar 50 for outputting power of the power storage element group 60, the long bus bar 40 that is for outputting power of the power storage element group 60 and is longer than the short bus bar 50 with regard to the arrangement direction, and the insulating member 31 for insulating and holding the short bus bar 50 and the long bus bar 40, the insulating member 31 includes the first unit 10 for holding one end portion of the long bus bar 40 and the second unit 20 for holding the other end portion of the long bus bar 40, the first unit 10 has the first overlapping portion 12, the second unit 20 has the second overlapping portion 22, the first overlapping portion 12 and the second overlapping portion 22 have the overlapping margin 23 and overlap each other along the arrangement direction, the length of the overlapping margin 23 in the arrangement direction is variable, and the long bus bar 40 is selected from the high-profile side long bus bar 40B and the low-profile side long bus bar 40A that have different lengths in the arrangement direction.

The length of the insulating member 31 in the arrangement direction can be changed by changing the length of the overlapping margin 23 where the first overlapping portion 12 and the second overlapping portion 22 overlap each other with regard to the arrangement direction. Accordingly, the long bus bars 40 having different lengths can be held by the insulating member 31 without manufacturing components having different lengths. As a result, a plurality of types of components need not be manufactured in correspondence to the long bus bars 40 having different lengths, and thus it is possible to reduce the manufacturing cost of the external connection module 30.

### Other Embodiments

(1) Although this embodiment is configured such that the high-profile power storage module 90B have fourteen power storage elements 61 and the low-profile power storage module 90A has ten power storage elements 61, the number of power storage elements 61 in the high-profile power storage module 90B and the number of power storage elements 61 in the low-profile power storage module 90A are not limited to the above-described numbers.

(2) In Embodiment 1, a plurality of high-profile power storage modules 90B may be housed in the case 101, or a plurality of low-profile power storage modules 90A may be housed in the case 101.

(3) Although Embodiment 1 is configured such that two types of power storage modules 90, namely, the high-profile power storage module 90B and the low-profile power storage module 90A, are housed in the case 101, a configuration may be adopted in which three types or more of power storage modules 90 having different heights in the up-down direction are housed in the case 101.

(4) Although Embodiment 1 is configured such that the plurality of power storage elements 61 are stacked in the up-down direction and are arranged side-by-side, there is no limitation thereon, and a configuration may be adopted in which the power storage elements 61 are arranged side-by-side in the front-rear direction or the right-left direction.

(5) The step portion 24 may be omitted.

(6) Although a configuration is adopted in which the long bus bar 40 and the short bus bar 50 are wide, there is no limitation thereon, and a configuration may be adopted in which the long bus bar 40 and the short bus bar 50 are narrow and elongated in the up-down direction.

(7) The power storage elements 61 may be secondary batteries or capacitors.

### LIST OF REFERENCE NUMERALS

10: First unit
11: Upper wall
12: First overlapping portion
13: First locking claw
14: Guide portion
15: First locking claw
20: Second unit
21: Partition
22: Second overlapping portion
23: Overlapping margin
24: Step portion
25: Second locking claw
26: Guide receiving portion
27: Second locking claw
30: External connection module
30A: Low-profile external connection module
30B: High-profile external connection module
31: Insulating member
40: Long bus bar
40A: Low-profile side long bus bar
40B: High-profile side long bus bar
41: Long side external connection portion
42: Long side bus bar connection portion
43A: Low-profile side intermediate portion
43B: High-profile side intermediate portion
44: Through-hole
45: Locking rib
46: Locking hole
50: Short bus bar
51: Short side external connection portion
52: Short side bus bar connection portion
53: Through-hole
60: Power storage element group
60A: Low-profile power storage element group
60B: High-profile power storage element group
61: Power storage element
63: Electrode terminal
70: Wiring module
70A: Low-profile wiring module
70B: High-profile wiring module
71: Insulating protector
72A: Low-profile side frame
72B: High-profile side frame
73: Stacking unit
74: Housing portion
74L: Left housing portion
74R: Right housing portion
75: Locking receiving portion
80: Bus bar
81: First output bus bar
82: Second output bus bar
90: Power storage module
90A: Low-profile power storage module
90B: High-profile power storage module
100: Power storage pack
101: Case
110: External connection module system

What is claimed is:

1. A power storage pack comprising a plurality of power storage modules,
wherein the plurality of power storage modules each include a power storage element group in which a plurality of power storage elements having electrode terminals are arranged side-by-side in an arrangement direction, and an external connection module that is electrically connected to the electrode terminals of the plurality of power storage elements,
the external connection module includes a short bus bar for outputting power of the power storage element group, a long bus bar that is for outputting power of the power storage element group and is longer than the short bus bar with regard to the arrangement direction, and an insulating member for insulating and holding the short bus bar and the long bus bar,
the insulating member includes a first unit for holding one end portion of the long bus bar and a second unit for holding another end portion of the long bus bar with regard to the arrangement direction, the first unit has a first overlapping portion, the second unit has a second overlapping portion, the first overlapping portion and the second overlapping portion have an overlapping margin in which they overlap each other along the arrangement direction, and a length of the overlapping margin in the arrangement direction is variable, and
the plurality of power storage modules include a plurality of types of power storage modules to which a plurality of types of long bus bars having different lengths in the arrangement direction are attached.

2. The power storage pack according to claim 1,
wherein an amount of change in the length of the overlapping margin with regard to the arrangement direction is more than or equal to a thickness of a power storage element with regard to the arrangement direction.

3. The power storage pack according to claim 2,
wherein the first unit or the second unit is provided with a step portion that is recessed in a direction that intersects with the arrangement direction, and the first overlapping portion and the second overlapping portion overlap each other in the step portion.

4. The power storage pack according to claim 1,
wherein the long bus bar is wide in a width direction orthogonal to the arrangement direction,
the long bus bar has a locking rib extending from a side edge extending in the arrangement direction in a direction that intersects with a plate surface of the long bus bar, and
the first unit or the second unit has a locking claw for restricting separation of the long bus bar from the first unit or the second unit as a result of the locking claw being locked to the locking rib.

5. The power storage pack according to claim 1,
wherein a wiring module is arranged on the power storage element group,
the wiring module includes a plurality of bus bars connected to the electrode terminals of the plurality of power storage elements and an insulating protector for holding the plurality of bus bars, and
the external connection module is arranged on a side opposite to the power storage element group with respect to the wiring module.

6. An external connection module system comprising an external connection module that is electrically connected to a power storage element group in which a plurality of power storage elements are arranged side-by-side in an arrangement direction,
wherein the external connection module includes a short bus bar for outputting power of the power storage element group, a long bus bar that is for outputting power of the power storage element group and is longer than the short bus bar with regard to the arrangement direction, and an insulating member for insulating and holding the short bus bar and the long bus bar,
the insulating member includes a first unit for holding one end portion of the long bus bar and a second unit for holding another end portion of the long bus bar, the first unit has a first overlapping portion, the second unit has a second overlapping portion, the first overlapping portion and the second overlapping portion have an overlapping margin in which they overlap each other along the arrangement direction, and a length of the overlapping margin in the arrangement direction is variable, and
the long bus bar is selected from a plurality of long bus bars having different lengths in the arrangement direction.
